(19) United States
(12) Patent Application Publication
(10) Pub. No.: US 2020/0339173 A1
(43) Pub. Date: Oct. 29, 2020

(54) STROLLER

(71) Applicant: Pidyon Controls Inc., New York, NY (US)

(72) Inventors: Ekaterina Kravchenko, Philadephia, PA (US); Alexis Grant, Allentown, PA (US); Velissa Van Scoyoc, Philadelphia, PA (US); Ahmet T. Becene, West Simsbury, CT (US); Peter Byar, Willingboro, NJ (US); Yaacov Goland, Pacific Palisades, CA (US)

(73) Assignee: Pidyon Controls Inc., New York, NY (US)

(21) Appl. No.: 16/956,438

(22) PCT Filed: Dec. 20, 2018
(86) PCT No.: PCT/US18/66925

§ 371 Date: Jun. 19, 2020

Related U.S. Application Data
(60) Provisional application No. 62/609,118, filed on Dec. 21, 2017.

(51) Int. Cl. B62B 7/06; B62B 9/08; B62B 9/10; B62B 9/18; B62B 9/20; B62B 9/26

(52) U.S. Cl. CPC B62B 7/066; B62B 9/082; B62B 9/087; B62B 9/104; B62B 2501/065; B62B 9/20; B62B 9/26; B62B 2501/04; B62B 9/18

(57) ABSTRACT

A stroller includes a foldable frame comprising carbon fiber. The frame is configured to removably connect to at least one of a stroller seat and an infant car seat. The stroller includes a plurality of wheels that support the frame, and a handle coupled to the frame. The stroller may include a suspension system including a leaf having a flexible cantilevered portion fixed at a first end thereof to the stroller frame. The cantilevered portion has a second, free end spaced from the frame. The cantilevered portion is configured to flex about the fixed end. The suspension system includes a damper disposed between the first and second ends of the cantilevered portion and the stroller frame. The damper is configured to compress and expand in response to flexing of the cantilevered portion. A wheel is connected to an underside of said cantilevered portion of the leaf.

### BACKGROUND

### 1. Field

The present disclosure relates to strollers.

### 2. State of the Art

A stroller is a wheeled seat configured for the transport of infants and toddlers. Strollers typically have the or four wheels supporting a frame and a seat, which may be removable. Also, strollers typically have a folding arrangement so that they can be more compactly stored when not in use. However, many strollers require the user to use two hands or assume an uncomfortable stance to reach the folding handles or latches used to initiate folding of the stroller, and/or to further assume an uncomfortable stance and bend to complete the folding operation of the stroller. Also, typical strollers are often made from many plastic and metal parts making them heavy to carry and labor intensive to assemble.

### SUMMARY

According to at least one aspect, further details of which are provided herein, a stroller includes a foldable frame comprised of carbon fiber. The frame is configured to removably connect to at least one of a stroller seat and an infant car seat. The frame is configured to be selectively unfolded in an in-use position and folded in a stowed position. The stroller includes a plurality of wheels that support the frame during use, and includes a handle coupled to the frame. The handle may be telescopically adjustable with respect to the frame. In one embodiment the frame includes rear legs pivotally coupled to sides of the frame. In the unfolded position, the rear legs extend at a non-zero angle relative to the sides of the frame and in the folded position the rear legs extend substantially parallel with the sides of the frame. In one embodiment, the sides of the frame have an arched flange having a maximum width at the center of the length of the side of the frame and the rear leg is pivotally connected to the flange at the center of the length of the side of the frame.

In one embodiment, the stroller includes a closeable storage container suspended from the rear legs below the stroller seat and infant car seat. In the folded and unfolded position the container remains intact and is not crushed or otherwise altered in shape or size as a result of the folded state of the stroller frame. Accordingly, a user need not empty the container of its contents before folding the stroller. The container is configured to be sealed and unsealed, such as with a zipper or hook and loop (Velcro®) closure to secure contents within the container. Also, the container could be closed with a drawstring, buckle, or other closure.

In one embodiment, the frame consists of carbon fiber. In another embodiment, the frame has at least one portion that includes carbon fiber and thermoplastic resin. In one embodiment, the frame has at least one portion that has an open profile. In one embodiment, the frame has at least one portion that has a closed profile, and the closed portion may be filed with foam, such as EPS foam. In one embodiment, at least one portion is formed of metal or plastic. For example, in one embodiment, the frame has a handle (rotatable or telescopic) that may be formed from a metal or plastic. For example, the handle may be formed from extruded aluminum or molded plastic.

According to another aspect, a stroller suspension system for supporting a stroller frame includes a suspension leaf having a flexible cantilevered portion fixed at a first end thereof to the stroller frame. The cantilevered portion has a second, free end spaced from the frame and from the first end. The cantilevered portion is configured to flex about the first, fixed end and is configured to connect to a wheel of the stroller on an underside of the cantilevered portion. The suspension system also includes an elastomeric damper disposed between the first and second ends of the cantilevered portion and the stroller frame. The elastomeric damper is configured to compress and expand in response to flexing of the cantilevered portion. In one embodiment, the suspension leaf is formed of carbon fiber.

According to yet another aspect, a stroller includes a frame configured to support at least one of a stroller seat and an infant car seat. The frame is configured to be selectively unfolded in an in-use position and folded in a stowed position. The stroller also includes a suspension system including a suspension leaf and an elastomeric damper. The suspension leaf has a flexible cantilevered portion fixed at a first end thereof to the stroller frame. The cantilevered portion has a second, free end spaced from the frame and the first end, and the cantilevered portion is configured to flex about the first, fixed end. The elastomeric damper is disposed between the first and second ends of the cantilevered portion and the stroller frame. The elastomeric damper is configured to compress and expand in response to flexing of said cantilevered portion. Also, the stroller includes a wheel connected to an underside of the cantilevered portion of the suspension leaf. In one embodiment, a damper may also be disposed on or in the frame and is not supported by a cantilevered member. For example, a damper may be used between portions of the sides of the frame to further dampen vibrations.

According to yet another aspect, a stroller system includes a stroller and at least one of a stroller seat and a car seat configured to removably connect to a frame of the stroller. The stroller includes a foldable frame comprising carbon fiber. The frame is configured to removably connect to at least one of a stroller seat and an infant car seat, and the frame is configured to be selectively unfolded in an in-use position and folded in a stowed position. The stroller includes a plurality of wheels that support the frame when in use, and a handle telescopically adjustable with respect to said frame.

According to yet another aspect, a stroller includes a foldable frame configured to removably connect to at least one of a stroller seat and an infant car seat. The frame is configured to be selectively unfolded in an in-use position and folded in a stowed position. The frame includes at least one hollow tubular portion filled with foam. The stroller includes a plurality of wheels that support the frame when in use, and a handle telescopically adjustable with respect to the frame. In one embodiment, the frame includes portions having varied stiffness.

### BRIEF DESCRIPTION OF THE DRAWINGS

FIG. 1 is an isometric view of a stroller in a fully open configuration connected to a stroller seat in a forward facing orientation accordance with an aspect of the disclosure.

FIG. 2 is a side elevation view of the stroller of FIG. 1, with the stroller seat in a rearward facing orientation and shown in stages of being reclined.

FIG. 3 shows the stroller of FIGS. 1 and 2 in a fully closed or folded configuration.

FIG. 4 is an isometric view of the stroller of FIGS. 1 to 3 in a fully open configuration and connected to a removable car seat, which is in a rear facing orientation, in accordance with an aspect of the disclosure.

FIG. 5 shows the stroller of FIG. 1 with padding and upholstery omitted for clarity of illustration.

FIG. 6a shows a handle bar and an actuator for adjusting a height of the handlebar in accordance with an aspect of the disclosure.

FIG. 6b shows the actuator in a neutral position.

FIG. 6c shows the actuator in an actuated position.

FIG. 7a shows details of latches at lower ends of sides of the handle.

FIG. 7b shows the latch in a locked position.

FIG. 7c shows the latch in an unlocked position.

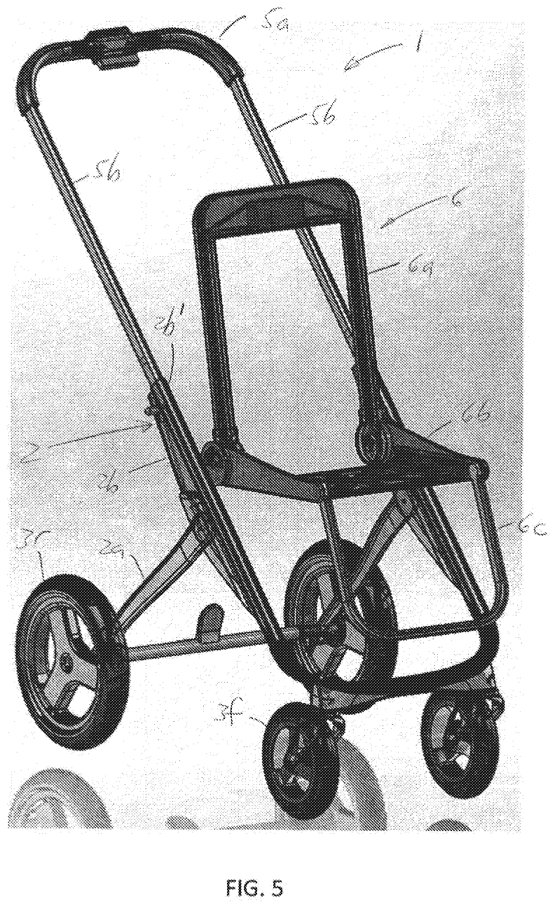

FIG. 5a shows a rear leg locking arrangement.

FIG. 8b shows the rear legs and the stroller frame in an open or unfolded position.

FIG. 8c shows the rear legs and the stroller frame in a closed or folded position.

FIG. 8d shows a view of a leg folding mechanism in a locked position where the leg is in an unfolded position.

FIG. 8e shows a view of a leg folding arrangement in a locked position where the leg is in a folded position.

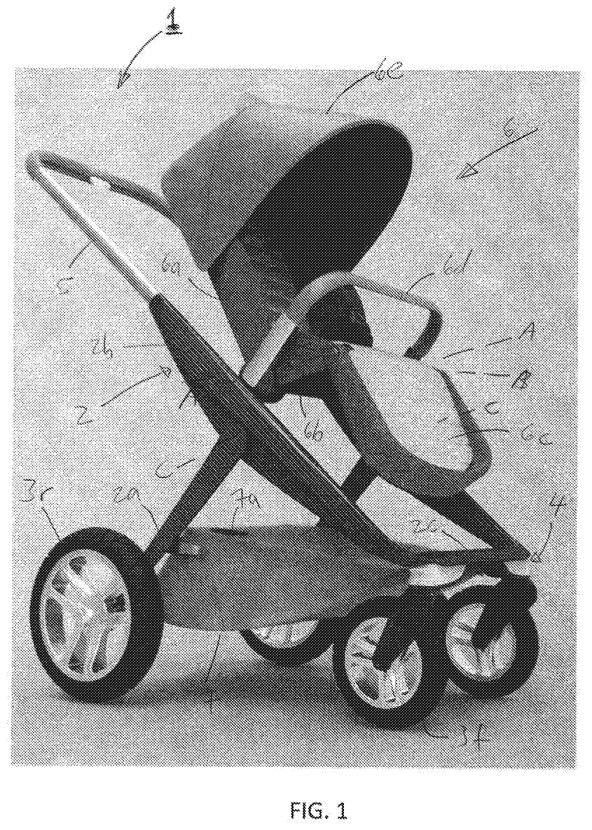

FIG. 9a is a skeletal view of the stroller seat shown in FIG. 1.

FIG. 9b is an exploded view of a seat recline mechanism.

FIG. 9c shows a view of the stroller seat of FIG. 9a with a seat back portion in a fully folded position.

FIG. 9d shows additional details of the seat recline mechanism of FIG. 9b and a linkage coupled to the seat back portion of the stroller seat.

FIG. 9e shows a locking pin of the linkage of FIG. 9d in a disengaged or unlocked position from one of the slots of the recline mechanism.

FIG. 9f shows the locking pin of FIG. 9e moved into alignment with another slot of the recline mechanism.

FIG. 9g shows the locking pin of FIG. 9f moved into engagement with the aligned slot of the recline mechanism.

FIG. 10a shows a portion of a rear axle and brake of the stroller of FIG. 1.

FIG. 10b shows details of the rear axle and brake shown in FIG. 10a.

FIG. 10c shows movement of the brake into a locked position.

FIG. 10d shows movement of the brake into an unlocked position.

FIGS. 11a, 11b, and 12 show details of an embodiment of the side of the stroller frame.

FIG. 11b shows a view of the side of the stroller frame along section 11b-11b in FIG. 11a.

FIG. 13 shows details of a suspension system for the stroller of FIG. 1.

FIGS. 14 and 15 shows further details of the container shown in FIG. 1.

FIG. 16 shows an alternate embodiment of a container.

FIG. 17 shows yet another embodiment of a container.

FIGS. 18 and 19 show the stroller frame of FIG. 1 in an open configuration and configured for use with the container shown in FIG. 17.

FIGS. 20 and 21 show the stroller of FIGS. 18 and 19 in an intermediate folding position.

FIGS. 22 and 23 show the stroller of FIGS. 18 and 19 in a fully folded configuration.

FIG. 24 shows a schematic illustration of an embodiment of a compression molding process in accordance with an aspect of the disclosure.

### DETAILED DESCRIPTION

FIG. 1 shows an embodiment of a stroller 1 in accordance with an aspect of the disclosure, shown in a fully open configuration. The stroller 1 includes a seat frame 2 supported by front wheels 3f and rear wheels 3r and a suspension system 4. The stroller 1 also includes a handle 5, which can telescopically adjust in length with respect to the frame 2. The stroller 1 may be provided as a kit that includes the frame 2 and a stroller seat 6.

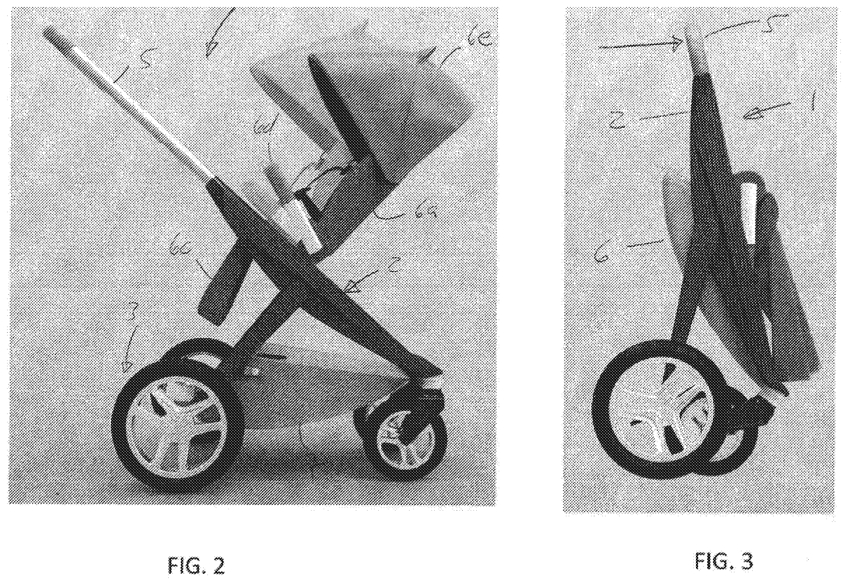

The frame 2 is configured to selectively, removably connect and disconnect from the stroller seat 6 without using tools, i.e., the stroller seat 6 may connect to the frame 2 using a snap fit connection. The frame 2 may have seat mounts 1200 (FIG. 12) on sides 2b of the frame 2 for mating with and connecting to mating connectors (e.g., 60, FIG. 12) of the stroller seat 6. Further details of the seat mounts 1200 and connectors of the seat 6 are provided below. The stroller 1 may be configured to connect the stroller seat 6 in forward facing orientations or rear facing orientations. For example, the seat 6 in FIG. 1 is forward facing, while the seat 6 in FIG. 2 is rear facing.

When the stroller seat 6 is connected to the frame 2, the entire stroller seat 6 can be selectively rotated about a horizontal axis A-A, such as to adjust the amount of recline of the seat 6 about axis A-A. In addition, various portions of the stroller seat 6 may pivot relative to each other. In the embodiment of the seat 6 shown in FIGS. 1 and 2, the stroller seat 6 has a back portion 6a, a seat portion 6b, and a leg portion 6c which have pivotal connections: the back portion 6a and the seat portion 6b are pivotally connected to each other about a hinged connection aligned with the axis A-A; and the seat portion 6b and the leg portion 6c are pivotally connected to each other about an a hinged connection aligned with axis B-B. Also, the seat 6 has a grab bar 6d, which is also pivotally connected to the hinged connection of the back portion 6a and the seat portion 6b, and, thus, is also configured to rotate about axis A-A independently of the back portion 6a and the seat portion 6b.

The back portion 6a is configured to pivot about axis A-A relative to the seat portion 6b for adjustment of the angle therebetween, and the leg portion 6c is configured to pivot relative to the seat portion 6b for adjustment of the angle therebetween. The angle between the back portion 6a and the seat portion 6b can be adjusted independently of the angle between the seat portion 6b and the leg portion 6c. Suitable adjustment and locking devices, described in greater detail below, may be used to adjust and lock the relative position between the back portion 6a, seat portion 6b, the leg portion 6c, and the grab bar 6d. The seat 6 also includes a retractable canopy 6e, which can open and close, fully or partially.

The frame 2 has rear legs 2a pivotally coupled to the sides 2b of the frame 2. The mar legs 2a are configured to pivot about axis C-C, which is parallel to axes A-A and B-B in FIG. 1. The rear wheels 3r are connected to the rear legs 2a of the frame 2. The rear legs 2a are configurable to rotate relative to the sides 2b of the frame 2 between an open configuration (shown in FIGS. 1 and 2) and a folded configuration (shown in FIG. 3). The movement between the open and folded configurations is selectively controlled by a user either opening or folding the stroller 1, as will be described in greater detail below.

The frame 2 also has a front member 2c connected between the sides 2b of the frame at a lower end of the frame 2. The sides 2b and front member 2c are preferably a unitary structure formed without mechanical connectors therebetween, and in one embodiment are made of carbon fiber. In the example embodiment shown in FIG. 1, the sides 2b and front member 2c resemble a u-shaped member, which may be unitary and formed of carbon fiber. As discussed below, the unitary u-shaped member may have portions that are wholly or partially closed or open profile and may or may not be filled with materials, such as foam. In one embodiment, the u-shaped member formed by the sides 2b and the front member 2c the frame 2 may be formed into two (e.g., halves) or more pieces connected together. In one embodiment, three pieces may be used and can be joined together via a central front member 2c.

The stroller 1 may include a storage container 7 or basket located below the seat 6 and is supported by the rear legs 2a and the front member 2c of the frame 2. The container 7 extends generally horizontally in FIGS. 1 and 2 when the stroller 1 is fully open and unfolded, and extends generally vertically in FIG. 3 when the stroller 1 is closed and fully folded. The container 7 may have a closure 7a (FIG. 1), such as a hook and loop closure or a zippered closure to securely contain or seal any contents stored in the container 7. In the folded configuration, the storage container 7 swings between the rear wheels 3r and, thus, remains intact since it is not crushed or compressed by the frame 2 due to folding. This means that the contents of the container 7 do not have to be emptied prior to folding and placed back into the container 7 after unfolding. The storage container 7 may be removable from the frame 2, such as for cleaning or storage or transportation separately from the frame 2. Further details of the container 7 and its operation are described below.

The stroller 1 can be folded with the stroller seat 6 connected to or removed from the frame 2. If the stroller seat 6 is connected to the frame 2, as shown in FIG. 1, the stroller 1 can be folded as follows. The canopy 6e may be retracted so that is lies substantially parallel with the back portion 6a. The seat portion 6b and the leg portion 6c may be straightened so that they extend straight and parallel to one another and substantially parallel to the sides 2b of the frame 2. The back portion 6a and the grab bar 6d can be rotated towards the seat portion 6b and leg portion 6c (i.e., clockwise in FIG. 1) so that they also extend substantially parallel with the sides 2b of the frame 2. Before folding the stroller frame 2, the telescoping handle 5 can be retracted fully into the sides 2b of the frame 2, as shown in FIG. 3. Then, once a release mechanism (e.g., handle 83 FIG. 8a, discussed in greater detail below) is actuated by a user to unlock the rear leg 2a to freely fold, the entire stroller 1 can be pivoted clockwise about the front wheels 3f by pushing on the retracted handle 5 in the direction of the arrow as shown in FIG. 3. When the rear leg 2a is unlocked, the pivoting motion of the stroller about the front wheels 3f causes the rear leg 2a to pivot about axis B-B towards the front wheels 3f, and cause the container 7 to swing upwardly in an arc into a generally vertical orientation next to the folded seat 6, as shown in FIG. 3. Once the stroller 1 is in the folded configuration, the stroller frame 2 will remain locked in the folded configuration until a user unlocks it by actuating the aforementioned release mechanism to open the stroller 1 in the configuration shown in FIGS. 1 and 2. For example, to open the stroller 1, after actuating the release mechanism, a user can rotate the entire stroller 1 counterclockwise about the rear wheels by pushing the handle 5 in the opposite direction to the arrow shown in FIG. 3. This will cause the container 7 to rotate back into its generally horizontal orientation and will cause the rear wheels 3r to rotate away from the front wheels 3f shown in FIGS. 1 and 2. Then, the user can unfold the seat 6 and reposition the back portion 6a, seat portion 6b, leg portion 6c, grab bar 6d, and canopy as desired by the user.

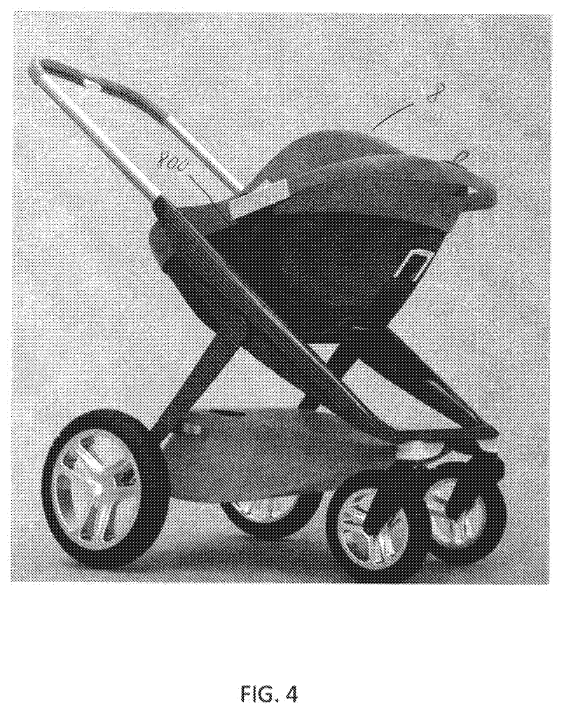

FIG. 4 shows the stroller frame 2 connected to a car seat 8, which may be one or other of car seats described in U.S. Pat. No. 8,911,015 (Cohen et al.), U.S. Pat. No. 9,487,110 (Cohen et al.). U.S. Patent Application Publication No. U.S. 2016/0059748 (Cohen et al.). U.S. Pat. No. 9,616,782 (Cohen et al.), U.S. Patent Application Publication No. 2016/0332542 (Cohen et al.) and U.S. Provisional Patent Application No. 62/569,090 (Cohen et al.). The frame 2 is configured to selectively, removably connect and disconnect from the car seat 8 without using tools, i.e., the car seat 8 may connect to the frame 2 using a snap fit connection. The frame 2 may have seat mounts 1200 (FIG. 12) on sides 2b of the frame 2 for mating with and connecting to mating connectors (vertical tabs in FIG. 4) 800 of the car seat 8. Further details of the seat mounts 1200 are provided below. The stroller frame 2 may be configured to connect the car seat 8 in forward facing orientations or rear facing orientations. For example, the car seat 8 in FIG. 4 is rear facing.

The terms stroller seat 6 and car seat 8 are used to distinguish different categories of occupant seats. Mirriam-Webster's online dictionary defines a car seat as a portable seat for an infant or a small child that attaches to an automobile seat and holds the child safely. Thus, car seats are configured specifically to provide crash protection to an occupant of the car seat attached to vehicle seat. When a car seat is detached from a vehicle seat and removed from the vehicle, it may be connected to the stroller frame 2 so that the infant or small child in the car seat can be moved with the stroller frame 2. The stroller seat 6 is specifically configured to connect to the stroller frame 2, but is not configured to attach to an automobile seat, and is not specifically configured to provide crash protection for an occupant of the stroller seat in a vehicle. The stroller seat, however, may be occupied by the same infants or small children who may occupy the car seat. For example, a parent may transfer an infant or small child from a car seat (that remains attached to a vehicle seat) to the stroller seat rather than detaching the car seat from the vehicle seat and connecting the car seat to the frame 2.

FIG. 5 shows the stroller 1 and stroller seat 6 in skeletal form and without padding and upholstery shown in FIGS. 1 to 3 to show greater detail of various mechanisms used for operating the stroller 1, such as mechanisms for telescopically adjusting the handle 5, for reclining the back portion 6a relative the seat portion 6b, folding the rear legs 2a, and locking the rear wheels 3r.

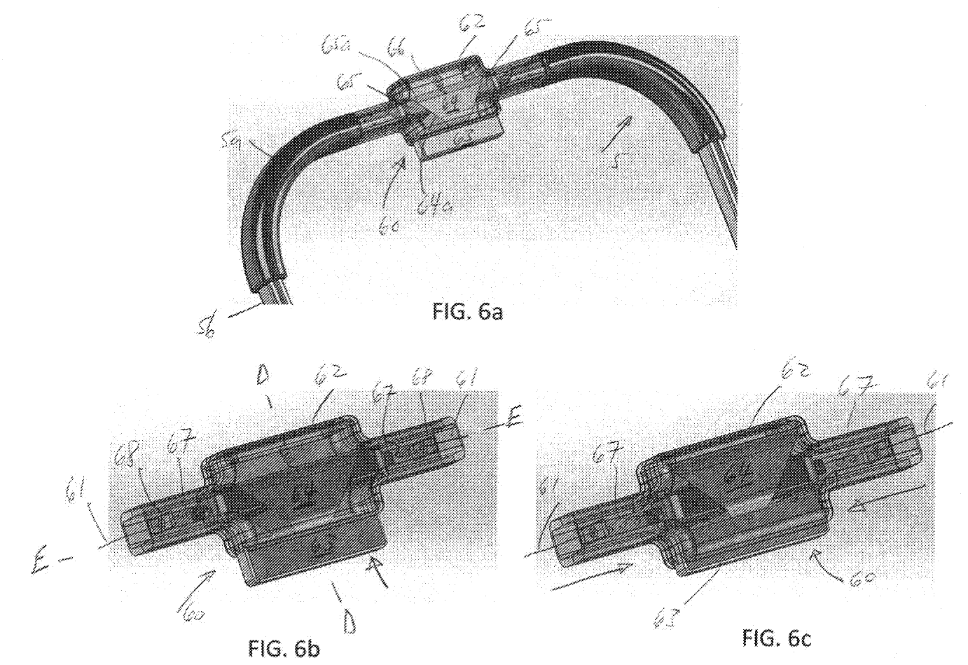

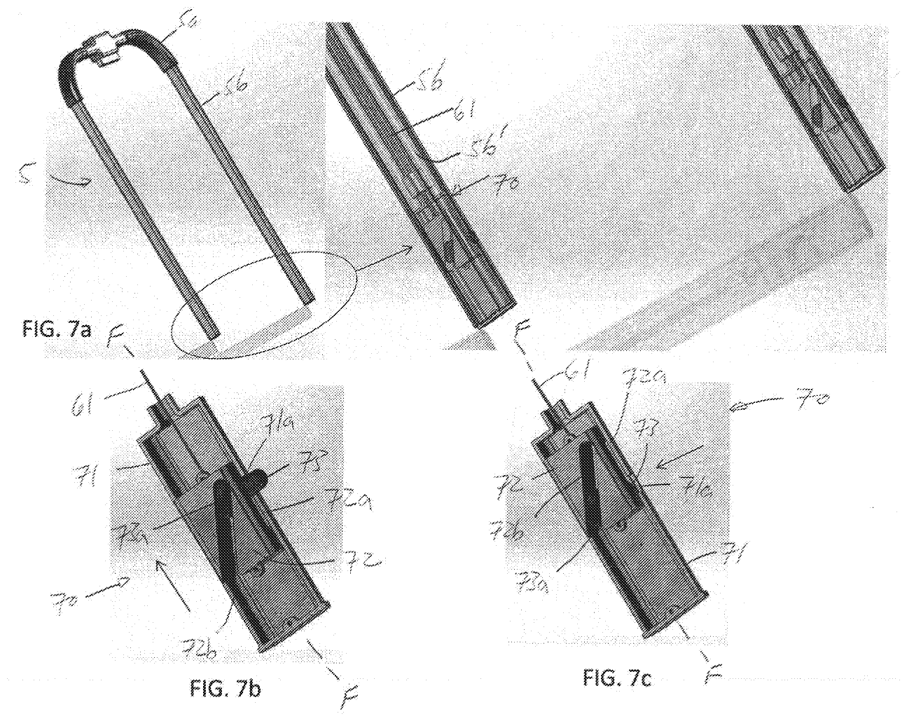

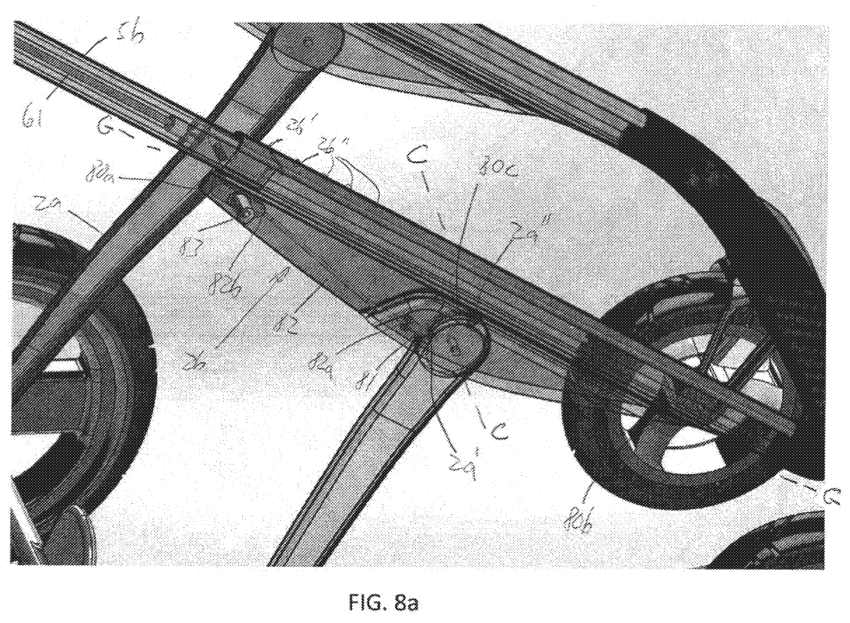

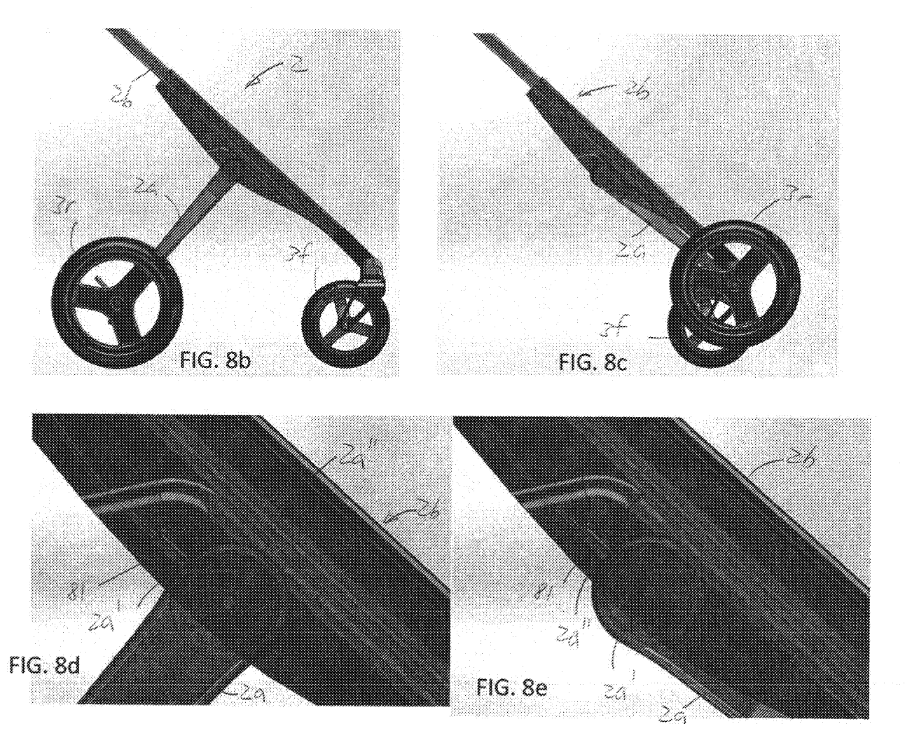

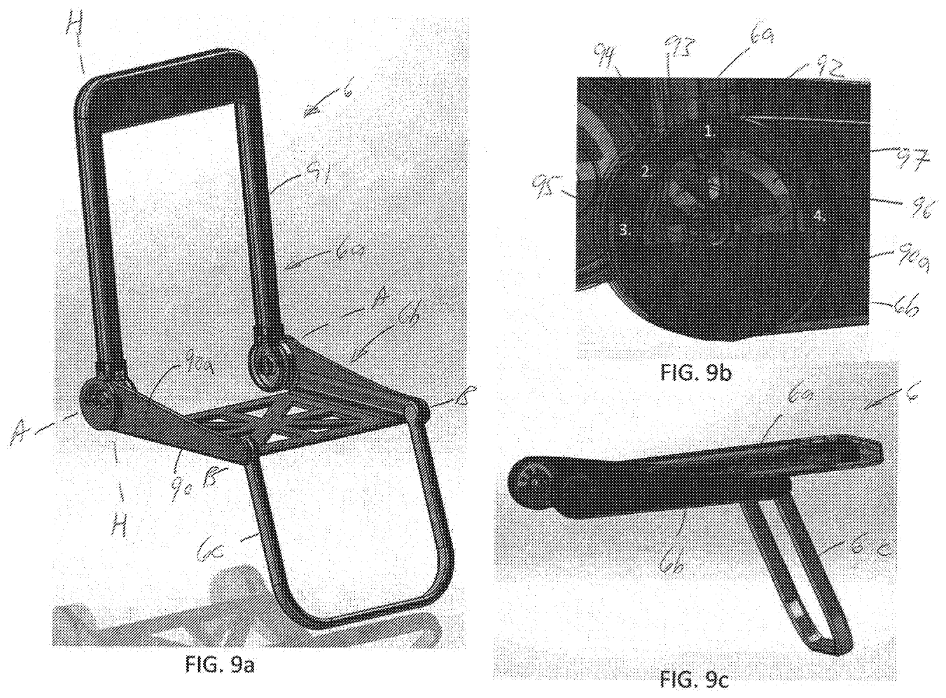

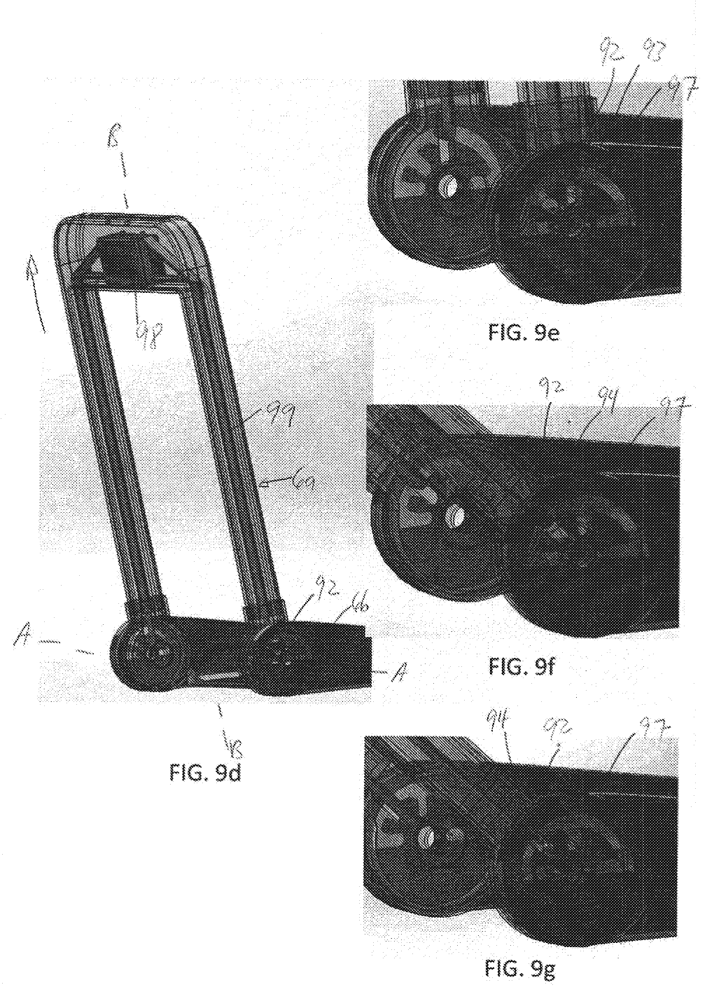

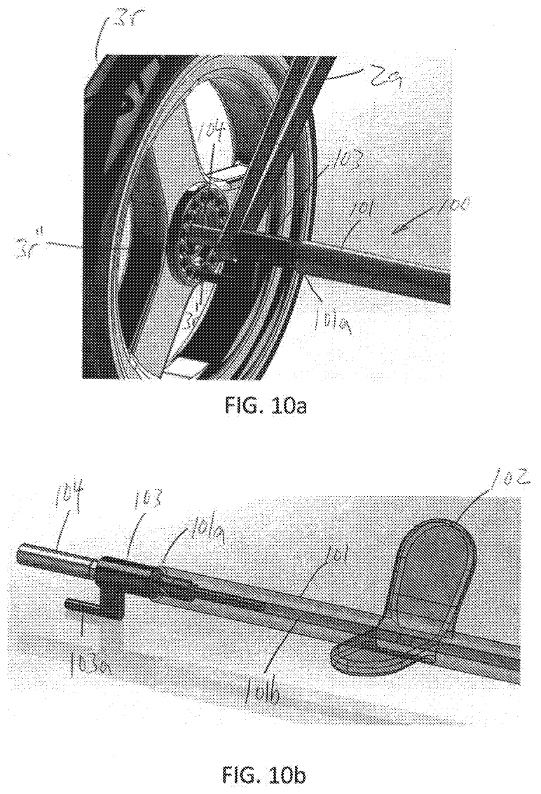

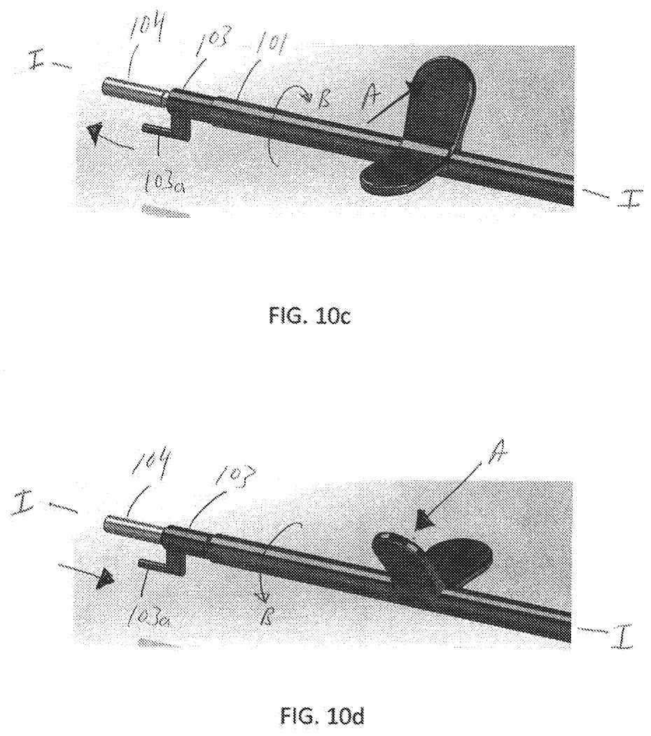

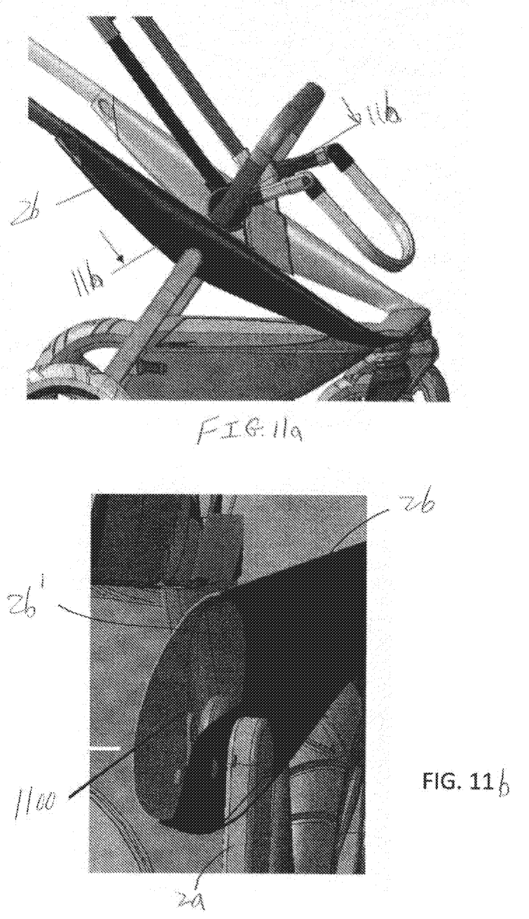

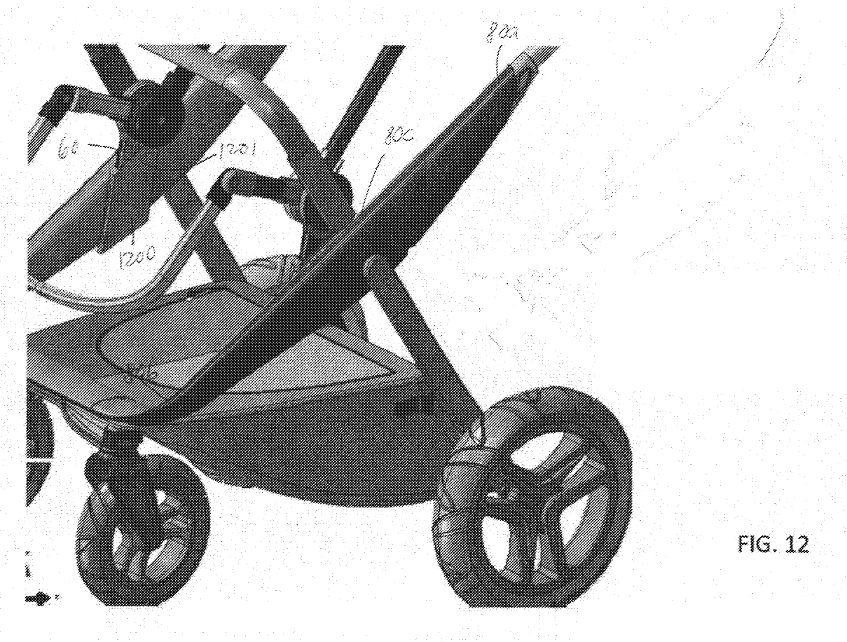

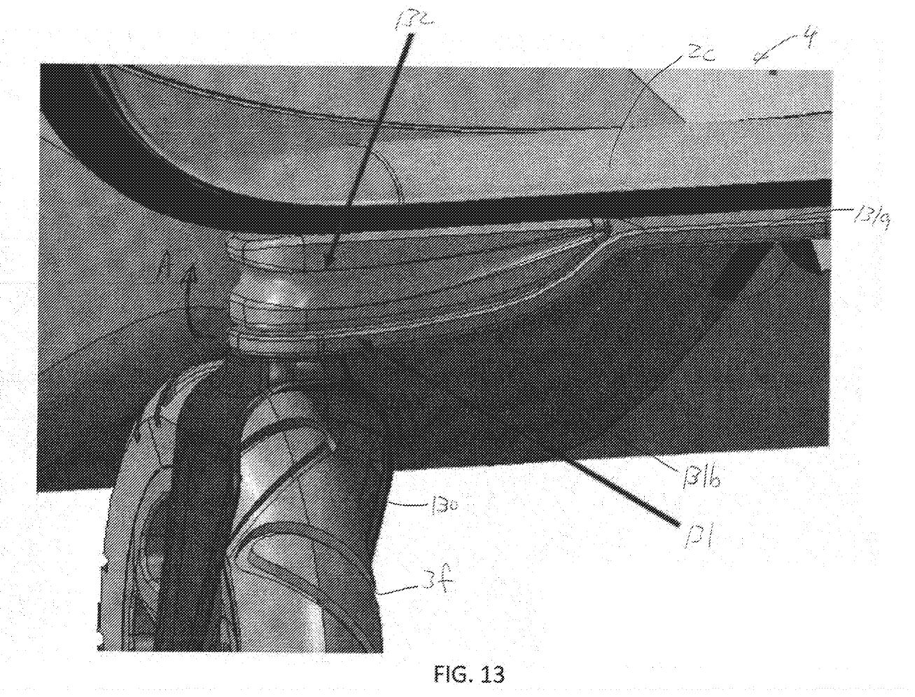

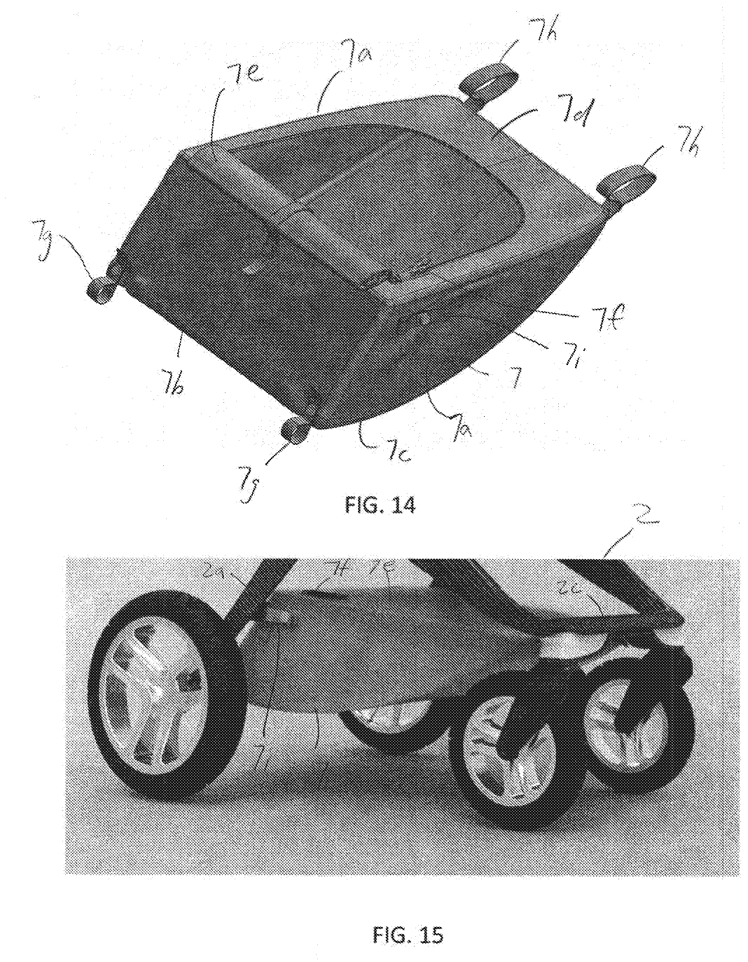

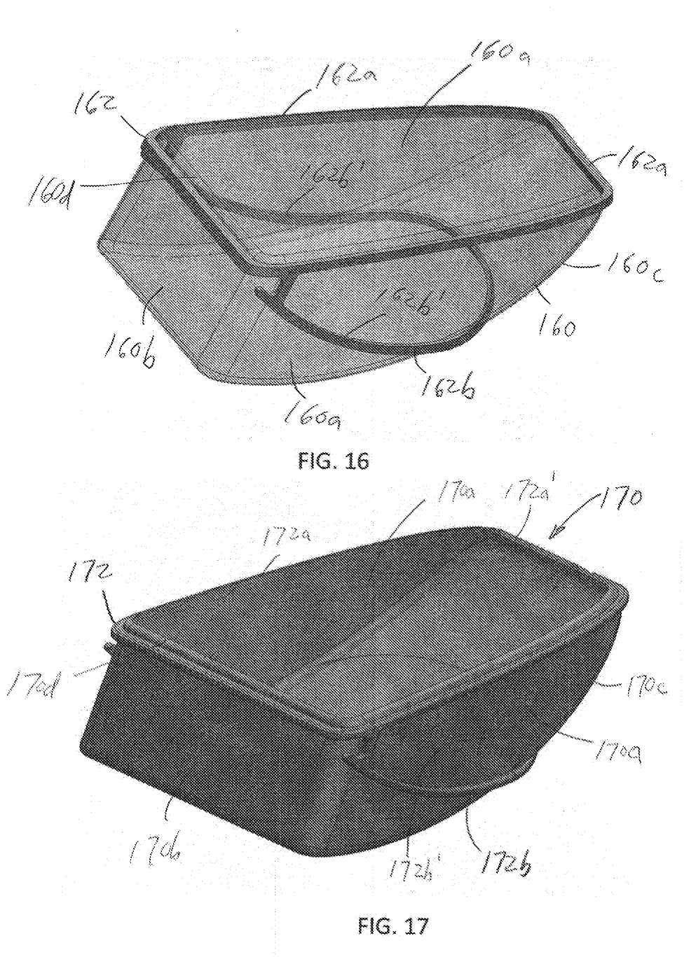

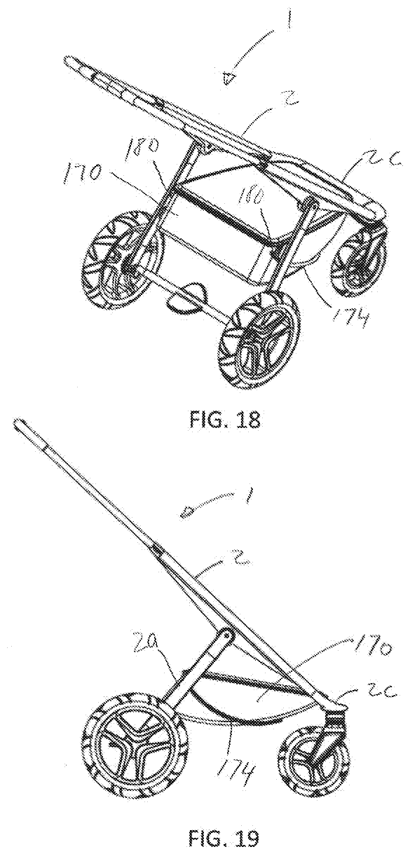

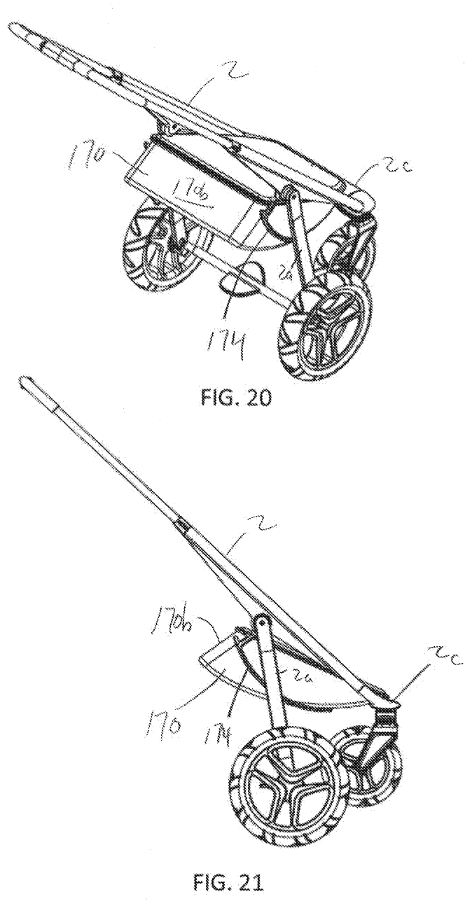

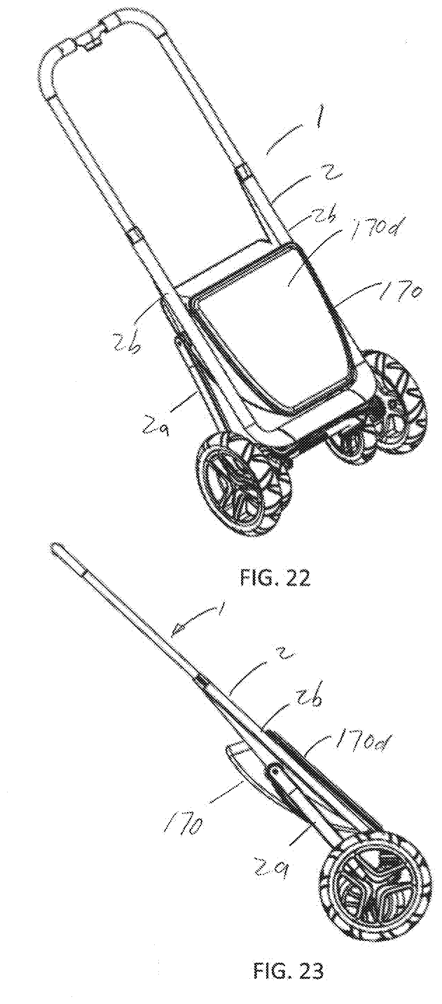

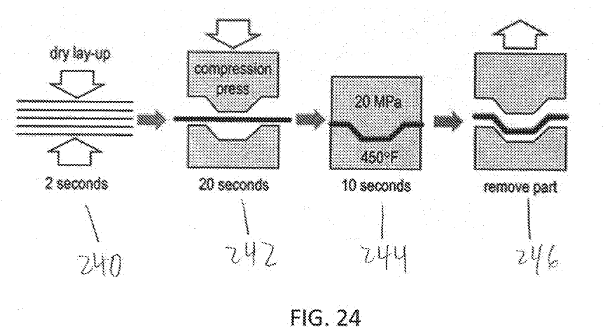

FIGS. 6a to 6c show exploded views of the handle in FIG. 5. The handle includes a handle bar 5a with an actuator 60 for selectively operating a latch 70 (FIGS. 7a to 7c, described in detail below) by moving a linkage 61, which extends from the actuator 60 through the sides 5b of the handle 5 to the latch 70. The actuator 60 has a housing 62 that houses a plurality of elements 63, 64, 65, and 66 described below, which are arranged as an actuating mechanism to selectively move linkage 61. The actuator 60 has a neutral position (FIGS. 6a and 6b) in which the handle 5 is locked in position relative to the frame 2.

The actuator 60 includes a push button 63 connected to a central engagement member 64, which has opposed ramped surfaces 64a. In the neutral position shown in FIG. 6a, the button 63 protrudes from the housing 62. The button 63 and central engagement member 64 are both configured to move along axis D-D. Specifically, the button 63 and central engagement member 64 are configured to move from the neutral position in the direction of the arrow in FIG. 6b by a user pushing on the button 63 to an unlock position, and the button 63 and central engagement member 64 are configured to move from the unlock position to the neutral position automatically upon release of button 63.

The actuator body 62 also houses a pair of side engagement members 65 on opposite sides of the central engagement member 64. The side engagement members 65 are each connected to respective linkages 61. The side engagement members 65 have respective ramped surfaces 65a that are configured to slide relative to the opposed ramped surfaces 64a of the central engagement member 64. The side engagement members 65 are biased towards each other due to respective compression springs 67 (FIGS. 6b and 6c) supported by supports 68 (FIGS. 6b and 6c), such that when the button 63 is pushed inwardly from the neutral position in the direction of the arrow shown in FIG. 6b, the side engagement members 65 slide along surfaces 64a of the central engagement member 64 as it moves inwardly along axis D-D, thereby permitting the side engagement members 65 to move closer to each other along transverse axis E-E, as shown between the states in FIGS. 6b and 6c. When the side engagement members 65 move toward each other they pull on the linkages 61, which draws the opposite end of the linkages 61 upwards along sides 5b of handle 5, shown in the change between FIG. 7b and FIG. 7c.

FIGS. 7a to 7c show details of the latch 70 at the lower end of the sides 5b of the handle 5. In the embodiment shown in FIGS. 7a to 7c, the sides 5b are tubular and define a hollow lumen 5b′ in which the linkage 61 and the latch 70 are disposed. The latch 70 includes a housing 71 that houses a ramp 72 and locking pin 73. The lower end of each linkage 61 is connected to a respective ramp 72. The housing 71 is fixed to the lower ends of the sides 5b of the handle 5, while the ramp 72 and the pin 73 are configured to move relative to each other and the housing 71. The pin 73 is configured to operatively project from the sides 5b in a locked position and retract into the sides 5b in an unlocked position. The sides 5b of the handle 5, together with the latch 70, are configured to selectively slide telescopically within a channel 2b′ (FIG. 8a) formed in the sides 2b of the frame 2 to adjust the height of the handle bar 5a.

As shown in FIG. 8a, each side 2b of the frame 2 defines a plurality of spaced holes 2b″ configured to communicate with the receiving channel 2b′. Each hole 2b″ may extend partially or completely through the side 2b. Each hole 2b″ is configured to selectively engage the locking pin 73 to lock or unlock the handle 5 relative to the sides 2b of the frame 2. Further details of the movement of the pin 73 are provided below with reference back to FIGS. 7b and 7c.

The ramp 72 is configured to translate along an axis F-F (FIGS. 7b and 7c) between a lower position in housing 71, as shown in FIG. 7b, and an upper position in housing 71, as shown in FIG. 7c. The axis F-F is aligned with sides 5b of the handle 5. The ramp 72 defines a side opening 72a. The ramp 72 defines a diagonally extending slot 72b, which extends at a non-zero angle with respect to axis F-F. The pin 73 has a slide member 73a that moves diagonally within the slot 72b based on the movement of the ramp 72. The pin 73 can move in a direction transverse to axis F—F based upon the movement of the slide member 73a in the slot 72b. Specifically, the pin 73 selectively extends through the side opening 72a in a locked position when the ramp 72 is in the lower position, and the pin 73 is retracted from the side opening 72a in an unlocked position when the ramp 72 is in the upper position. In the lower position of the ramp 72 shown in FIG. 7b, the slide member 73a is at the upper end of the slot 72b and the pin 73 extends through the side openings 71a and 72a in the locked position. When the ramp 72 moves to the upper position, as shown in FIG. 7c, the slide member 73 is located at a lower end of the slot 72b and further away (laterally, in a transverse direction from axis F-F) from side slot 72a, thereby retracting the pin 73 from the slot 72a into an unlocked position. The movement of the ramp 72, and thus the pin 73, is controlled by the movement of the linkage 61, which, as noted above, is controlled by actuation of the push button 63.

A user can adjust the height of the handle bar 5a above the ground as follows. If the pin 73 is initially engaged with a respective hole 2b″ (FIG. 5a), the handle 5 is locked with respect to the frame 2. To adjust the height of the handle bar 5a, a user can push on button 63 as shown in FIG. 6b, to cause the linkage 61 to be pulled up in handle sides 5b, which pulls the ramp 72 along axis F-F from the lower position shown in FIG. 7b to the upper position shown in FIG. 7c. As the ramp 72 rises, the engagement of the slot 72b with the slide member 73a causes the pin 73 to retract and move from the locked position to the unlocked position. When the pin 73 is in the unlocked position, the handle bar 5a is free to be moved to a desired position (e.g., a desired height from the ground). When the user sets handle bar 5a to the desired height, the user can release the push button 63, which permits the linkage 61 and the ramp 72 to return to the lower position shown in FIG. 7b to lock the pin 73.

FIGS. 8a to 8e show an arrangement for folding and locking the rear legs 2a of the frame 2 for folding the stroller 1. FIG. 8a shows details of a connection of a proximal end of one of the rear legs 2a to a flange 80 of the side of the frame 2. The proximal end of the rear leg 2a is pivotally connected to the flange 80 about axis C-C near a midpoint 80c of the length (along axis G-G) of the flange 80. The rear leg 2a is configure to pivot about axis C-C in FIG. 5a between the open position (shown in FIGS. 8a and 8b) and the folded position shown in FIG. 8c. The rear leg 2a defines a pair of holes 2a′ and 2a″ in the proximal end of the rear leg 2a. The holes 2a′ and 2a″ extend radially with respect to axis C-C. The holes 2a′ and 2a″ correspond respectively to an open, unlocked position of the rear legs 2a and a closed, folded position of the rear legs 2a. The holes 2a′ and 2a″ are configured to selectively align with and/or receive a locking pin 81 as described in greater detail below. The holes 2a′ and 2a″ can be aligned with a pin 81 by rotating the rear leg 2a about the axis C-C when the pin 81 is disengaged from the holes 2a′ and 2a″.

FIG. 8a shows a rigid linkage 82 that has a first end 82a connected to the locking pin 81 and has a second end 82b, opposite the first end 82a, connected to a handle 83, which is configured to be operated by a user. The handle 83 is accessible by a user from an outer side of the flange 80 and is configured for one-handed operation by a user.

The handle 83, the linkage 82, and the pin 81 are configured to translate in unison along axis G-G due to the rigidity of the linkage 82. In one embodiment, the handle 83 is biased (such as with a spring) towards the proximal end of the rear leg 2a. Thus, when the pin 81 aligns with either of the holes 2a′ or 2a″, and the handle 83 is released by a user, the pin 81 will automatically slide into engagement with the respective aligned hole 2a′ or hole 2a″. When the pin 81 engages either of the holes 2a′ or 2a″, the rear leg 2a is locked in position about the axis C-C, either in the folded or open position. As shown in FIGS. 8a and 8d, the pin 81 engages and locks in the hole 2a′ when the rear leg 2a is in the unfolded position, and the pin 81 engages and locks in the hole 2a″ when the rear leg 2a is in the folded position. A user can disengage the pin 81 from either of the holes 2a′ or 2a′, and thus unlock the rear leg 2a to permit the rear leg 2a to rotate about axis C-C, by pulling the handle 83 in a direction away from the proximal end of the leg 2a along axis G-G. When pin 81 is disengaged from holes 2a′ or 2a″ the rear leg 2a is free to move about the axis C-C between the unfolded position (FIGS. 8a. 8b, and 8d) and the folded position (FIGS. 8c and 8e). Thereafter, a user can release the handle 83 to lock the pin 81 again into either of holes 2a′ or 2a″ (if the handle 83 is biased) depending on whether the user is folding or unfolding the frame 2.

The frame 2 is configured to be folded and unfolded using only one hand to operate the handle 83 and without the user having to bend over to begin and end the folding operation. In addition to operating the handle 83 to unlock the legs 2a from the pin 81, when the stroller frame 2 is folded, a user may also kick or rock the frame 2a about the front wheels 3f to facilitate folding while keeping a second hand free at all times.

As shown more closely in FIG. 12, the flange 80 may have an arched shape that is analogous to an arc of a suspension bridge. Such an arched shape may provide maximum bending moment at the middle 80c of the length of the flange 80 and minimum bending moment at the ends 80a and 80b. This stiffens the sides of the frame 2b from bending and deflecting at the middle 80c where the leg 2a is connected to the sides 2b of the frame 1. The ends 80a and 80b of the flange 80 are shown having have smaller cross sections than the middle 80c to minimize material usage at the lower bending moment portions of the flange 80.

FIGS. 9a to 9g show further details of the stroller seat 6. The back portion 6a, a seat portion 6b, and a leg portion 6c are shown in skeletal form without padding and upholstery. The seat portion 6b includes a seat frame 90 and the back portion 6a includes a seat back frame 91 that are pivotally connected to each other about axis A-A. The frame 90 has sides 90a that define a plurality of radial slots 93, 94, 95, and 96 which are circumferentially spaced about axis A-A. The slots 93, 94, 95, and 9 are in communication with one another via a semicircular slot 97. Each slot 93, 94, 95, and 9 is configured to selectively receive a locking pin 92, which is connected to a linkage 99 extending along the back portion 6a, to set the angle between the back portion 6a and the seat portion 6b. For example, as shown in FIG. 9b, the seat portion 6b defines four slots numbered 93, 94, 95, and 96 corresponding to an upright (FIG. 9a), semi-reclined, fully reclined, and folded forward (FIG. 9c) positions of the back portion 6a.

FIG. 9d shows details of a handle 98, linkage 99, and the pin 92 inside the back portion 6a of the seat 6. The handle 98, linkage 99, and pin 92 are configured to move in unison along axis H-H, which is transverse to axis A-A. The handle 98, linkage 99, and pin 92 are biased towards the axis A-A so that the pin 92 is biased to move into one of the slots 93, 94, 95, and 96 when the pin 92 aligns with a respective one of the slots 93, 94, 95, and 96 and the handle 98 is released by a user. The handle 98 is configured to be displaced along axis H-H by a user to adjust the angle of the back portion 6a with respect to the seat portion 6b as follows.

To adjust the angle of the back portion 6a relative to the seat portion 6b a user can move the handle 98 along axis H-H in a direction away from the axis A-A, which will cause the pin 92 in FIG. 9d to move out of slot 93 and into the channel 97, as shown in FIG. 9e. When the pin 92 is displaced into the channel 97, the seat back portion 6a can be rotated about axis A-A to align the pin 92 with another one of the respective slots, e.g., slot 94, as shown in FIG. 9f. When the pin 92 is so aligned, a user can release the handle 98, causing the biased pin 92 to slide into the respective slot 94, as shown in FIG. 9g, thereby locking the seat back portion 6b in a different recline position (semi-reclined position in FIG. 9g) relative compared to the position shown in FIG. 9d (upright).

FIGS. 10a to 10d show a rear wheel foot brake and axle assembly 100. Only one side (left) of the assembly 100 is shown, since the other side (right) that is now shown is constructed in the same manner. The assembly 100 includes a central tube 101 extending horizontally, a translatable member 103 coupled to the ends of the central tube 101, and an axle pin 104 extending outwardly from the translatable member 103 through a distal end of the rear leg 2a and into a hub 3r′ of the rear wheel 3r. The axle pin 104 is pivotally coupled with the hub 3r′ of the rear wheel 3r and the pin 104 supports rear leg 2a, as shown in FIG. 10a. The tube 101 is hollow and has an end 101a that defines a bore 101b (FIG. 10b) having a female thread that mates with a male thread of the translatable member 103. A foot pedal 102 extends from the tube 101. The foot pedal 101 is configured to engage a foot of a user to rotate the tube 101 about its longitudinal axis I-I, as shown in FIGS. 10c and 10d, as described in more detail below.

The translatable member 103 is configured to translate along axis I-I as a result of the tube 101 rotating about axis I-I. The translatable member 103 is connected to a radially offset brake locking pin 103a that translates with the translatable member 103. The locking pin 103a is configured to selectively be inserted into and retracted from any one of a plurality of holes 3r″ defined on an inner side of the wheel 3r to lock and unlock the wheel 3r from rotating. For example, as shown in FIG. 10c, the translatable member 103 and locking pin 103a translate outwardly (toward the wheel 3r) into locking engagement with one of the holes 3r″ when the pedal 102 is pushed in the direction of the arrow A and the tube 101 rotates in the direction of the arrow B. Also, as shown in FIG. 10d the translatable member 103 and locking pin 103a translate inwardly (away from the wheels 3r) out of locking engagement with the holes 3r″ when the pedal 102 is pushed in the direction of the arrow A, which is opposite the direction in FIG. 10c, and the tube 101 rotates in the direction of the arrow B.

In addition to the brake and axle assembly 100, the stroller 1 may include a secondary safety brake that is configured to automatically engage whenever a user takes their hands off of the handle bar 5a. In one embodiment, the rear wheels are equipped with a bicycle style brake caliper and brake pads connected to a cable extending to a hand brake extending from the handle bar 5a. Such brake may be configured such that the user must squeeze the hand brake against the handle bar 5a to disengage the brake from the rear wheels. In one other embodiment, the handlebar 5a incorporates a hand sensor to determine whether a user's hands are in position grabbing the handle bar 5a. In such an embodiment, the rear wheels 3r may be equipped with a brake actuator and a brake mechanism that is connected to the hand sensor which can brake the wheels to prevent the stroller from moving when the sensor determines that a user's hand(s) are not located on the handle bar 5a. The hand sensor can be embedded into the handle bar 5a or can be a proximity sensor either on or near the handle bar 5a. In one embodiment, two sensors are employed: a first sensor configured to sense that a hand is grabbing the handle bar 5a; and a second sensor that is configured to determine if the user's body or hand is within a predetermined distance of the stroller. Such a predetermined distance may be about three feet to approximate an arms length of an adult human so as to allow the stroller handle bar 5a to be reached in the event the stroller begins to roll away.

FIG. 11b shows a view of the side 2b of the frame 2 along section 11b-11b shown in FIG. 11a. The frame 2 may be formed of various materials and preferably materials that have a high strength to weight ratio, such as carbon fiber, carbon epoxy composite, fiberglass, and aluminum alloy.

The use of carbon fiber or similar molded woven material can reduce or eliminate the need for connectors in the stroller frame 2. For example, stroller frames are typically constructed using sections of extruded metal forms that are fastened together using plastic connectors and fastening parts, such as threaded fasteners and rivets. The use of carbon fiber or similar molded woven materials allows for fewer connections between frame sections and for more complex frame shapes that can reduce or eliminate the need for mechanical fasteners, and reduce part count. Also, a molded carbon fiber frame has a high strength to weight ratio in comparison to other typical stroller frames made of steel and plastic. A molded carbon fiber frame or similar material can be designed so that the rigidity of the frame can vary throughout the frame depending on structural need. In that regard, variations in the rigidity may involve variations in shape of the stroller frame cross sections throughout the frame 2. Moreover, a carbon fiber frame 2 can be formed form closed or open channels which can house the above-described mechanisms for folding the stroller and adjusting and folding the seat 6.

As noted above, the sides 2b define a channel 2b′ for receiving the sides 5b of the handle 5. The side 2b may also define open channels or closed channels, such as closed channel 1100 in FIG. 11b. The channels may be filled or otherwise lined with foam, such as to increase the bending, torsional, and buckling resistance of the side 2b. The foam may be expanded polystyrene (EPS) foam, for example. In addition to the sides 2b, other portions of the frame 2, such as the rear legs 2a may be formed as open or closed channels that may be filled in like manner to the channels 1100.

In one embodiment the frame 2 is partially or wholly formed of carbon fiber sections having a closed profile, such as the profile of closed channel 1100 in sides 2b described above. In one embodiment, at least one portion of the carbon fiber frame includes a closed profile section filled with expanded foam that stiffens the closed profile section. Examples of foam include EPS, expanded polypropylene (EPP), and polyurethane (PU) foam. In one embodiment, the foam density can be varied throughout the closed profile sections of the frame to provide a desired frame stiffness in specific areas of the frame, such as the sides 2b, legs 2a, and front member 2c. The use of expanded foam in the frame 2 can be varied by maintaining void areas in the frame to further control the stiffness of the frame. For example, the sides 2b of the frame may be filled with foam of a first density while the front member 2c may be filled with foam of a second density different from the first density and an portion of the frame 2 between the sides 2b and the front member 2c may not be filled with any foam so that there is separation between the two foams. Also, in place of voids in the frame 2 to separate regions of foam, other elements, such as spacers and fasteners may be placed between areas of foam. Also, in another embodiment, in place of using foam spacers, a twisted carbon fiber sleeve may be used. Such a twisted carbon fiber sleeve may have a resultant cross-section of an I-beam.

In one embodiment, the frame 2 is partially or wholly formed of carbon fiber sections having an open profile. Typical methods of producing carbon fiber parts with a thermoset resin (e.g., epoxies and cyanate esters) include use of a vacuum bagging process and an autoclave curing process. The open profile carbon fiber parts described can also be made using a compression molding process using a thermoplastic (rather than a thermoset) resin. Non-limiting examples of thermoplastic resins that may be used include polyether ether ketone (PEEK), polyphenylene sulfide (PPS), and polyetherimide (PEI). In one embodiment the frame 2 is formed of carbon fiber and partially or wholly formed from sections having an open profile that are formed using a compression molding process. Such compression molding process may use ‘continuous fiber’ carbon fiber or recycled (“chopped”) carbon fiber molded compounds.

FIG. 24 shows an embodiment of a carbon fiber compression molding process which may be used to produce open profile, thermoplastic resin carbon fiber parts for the stroller 1. The specific numerical values of times, temperature, and pressure shown in FIG. 24 are merely exemplary and are not required. Compression molding of thermoplastic fiber components requires a slightly different process from that used with thermoset resin. For example, since thermoplastics simply melt instead of crosslink like thermosets, it is important to have tighter controls on the temperature of the thermoplastic material during compression molding. In FIG. 24, at step 240, layers of carbon fiber and thermoplastic are laid up before being compressed in a press at step 242. While being compressed, the laid up material is heated for a predetermined time at a predetermined temperature at step 244. Thereafter, the press is opened and the formed part is removed at step 246.

In comparison with the aforementioned vacuum bagging process used with thermoset resin carbon fiber parts, the compression molding process in accordance with this disclosure can reduce cycle (production) time for carbon fiber parts produced, which can lead to lower manufacturing costs. Thermoplastic resin impregnated composites are less brittle than thermoset parts. Also, thermoplastic resin parts can be recycled more easily than a carbon fiber part made with thermoset resin. Further, a thermoplastic resin carbon fiber part experiences less degradation to the resin from UV light and environmental exposure than carbon fiber parts made with thermoset resin.

FIG. 13 shows a detailed view of a left half of the suspension system 4 shown in FIG. 1. The suspension system 4 is connected to the frame 2 below the front member 2c. The front wheels 3f are connected to a fork 130 at a central hub of the wheel 3f. Disposed between the fork 130 and the front member 2c are a lower suspension leaf 131 and an upper elastomeric damper 132. The suspension leaf 131 has a central portion 131a between two cantilevered portions 131b on opposite sides (e.g., left and right sides) of the central portion 131a. The central portion 131a is fixed to the front member 2c, such as with fasteners. In one embodiment, the u-shaped member formed by the sides 2b and the front member 2c (FIG. 1) of the frame 2 may be formed into two (e.g., halves) or more pieces having a connection at the center of the front member 2c. In that embodiment, the two pieces can be joined together via the central portion 131a.

The cantilevered portion 131b acts as a leaf spring and can flex or otherwise pivot about its inner end 131b′ relative to the central portion 131a in response to vertical movement of the wheel 3f, such as when the stroller 1 is traveling over uneven or bumpy terrain. The suspension leaf 131 may be made of carbon fiber or other suitable materials with similar flexing capabilities. The elastomeric damper 132 is configured to undergo compression and extension in response to deflection of the cantilevered portions 131b of the suspension leaf 131. In the example shown in FIG. 13 the elastomeric damper 132 is in an uncompressed state. If the wheel 3f is displaced upward relative to the front member 2c, such as if the stroller 1 is in motion and the wheel 3f hits a curb or other bump in its path, the cantilevered portion 131b will flex about its end 131b in the direction of arrow A causing the elastomeric damper 132 to undergo compression. Thereafter, the compressed elastomeric damper 132 will dissipate the energy absorbed as a result of compression by expanding to its uncompressed state and restore the cantilevered portion 131b substantially to its undeformed position shown in FIG. 13. In this manner, the suspension system 4 permits the wheels 3f to travel up and down over rough terrain without interfering with the stroller frame stability.

The elastomeric damper 132 and the suspension leaf 131 can be optimized for various terrain. Some parameters that may be optimized include the density of the elastomer of the elastomeric damper 132 and the deflection (travel distance) of the suspension leaf 131 for a given load (i.e., the stiffness of the suspension leaf 131). For example, where the stroller 1 is designed to be used as a jogging stroller in an off-road environment, a predetermined elastomer density and stiffness of the suspension leaf 131 may be used. However, in another embodiment where the stroller is designed for urban terrain, such as cobblestone, at least one of the elastomer density of the damper 132 and the stiffness of the suspension leaf 131 may be different than the values used for the jogging stroller environment.

The elastomeric damper 132 provides dampening and energy absorption to isolate the occupant of the stroller 1 and the user from bumps when the stroller 1 travels over rough or uneven terrain. Specifically, the elastomeric damper 132 acts as a high pass filter to road bumps and dissipates shock energy from the wheels 3r when they move up and down over rough terrain. The flexing cantilevered portion 131b and elastomeric damper 132 can reduce vibration and energy that would otherwise be transmitted to and through the frame 2 by the wheels 3f, and, as a result, can provide more comfort for the rider and user of the stroller 1.

Also, a suspension leaf and damper can be provided between the rear wheels 3r and the legs 2a to further reduce vibration that may be transmitted through the rear wheels 3r. Additionally, the suspension leaf and damper can be provided between the connection between the legs 2a and the sides 2b of the frame 2 to further dampen vibrations transmitted at that connection. Also, for example, elastomeric materials may be used between the connection of the stroller seat 6 and the frame 2 to dampen vibrations transmitted from the frame to the stroller seat 6. Also, the damper may be located within portions of the frame 2, such as at the middle of the sides 2b to dampen vibrations.

As shown in FIG. 12, in one embodiment the stroller frame 2 includes seat mounts 1200 (one shown) connected to the sides 2b of the frame 2. The seat mounts 1200 are configured to removably connect to connectors of the stroller seat 6, car seat 8, and adapter plates which may be configured to connect specifically to other stroller seats, car seats, and bassinets that are not specifically made to connect to the seat mounts 1200. The mounts 1200 extend upright in a vertical direction. The mounts 1200 have slots 1201 that are configured to receive mating tabs 60 of the seat 6 that extend downward inside the slots 1201. The mounts 1200 and/or the tabs 60 may have a locking arrangement to secure the tabs 60 in the slots 1201 until and unless a user unlocks the tabs 60 from the slots 1201 to separate the seat 6 from the frame 2. The tabs 60 and slots 1201 are configured to mate and lock together when the seat 6 is forward facing or rear facing. Similarly, the vertically extending tabs 800 (only one tab 800 is shown in FIG. 4) that has a lower end like tabs 60 that mate with slots 1201 of mounts 1200.

FIG. 14 shows further details of the container 7 in FIG. 1. In one embodiment the container 7 has side walls 7a, a rear wall 7b, a curved bottom 7c, and a flat top 7d. The top 7d defines a cover 7e that is operably closed and opened by a closure, such as a zippered closure 7f. In FIG. 14, the container 7 is shown in an open configuration with the cover 7e folded over onto itself. FIG. 15 shows the container 7 in a closed configuration with the cover 7e closed with zipper 7f.

The container 7 also has a plurality of connectors 7g, 7h, and 7i for connecting the container 7 to the frame 2 of the stroller 1. The connectors 7g, 7h, and 7i are formed as loops. Connectors 7g are configured to connect the rear side 7b of the container 7 to the axle assembly 100 (FIG. 10a). Connectors 7h are configured to connect the bottom 7c of the container 7 to the front member 2c (FIG. 1) of the frame 2 (FIG. 1). Connectors 7i are configured to connect the sides 7a of the container 7 to the rear legs 2a (FIG. 1) of the frame 2 (FIG. 1). Connectors 7g, 7h, and 7i are configured to removably connect to the frame 2. As shown in FIG. 14, the connectors 7g and 7i include snap closures to permit the loops to open and close. When the frame 2 is open, the connectors 7g, 7h, and 7i are configured to connect to the frame 2. Before a user folds the frame 2, a user can disconnect the connectors 7g and 7i from the frame 2, while keeping connectors 7h connected to the front member 2c. Then, when the frame 2 is folded, the container 7 is free to pivot about the front member 2c while the rear side 7b will swing freely through the rear legs 2a and over the axle assembly 100, as shown in FIG. 3.

The container 7 may be at least partially rigid. For example, the container may include a relatively rigid frame that supports a flexible covering, which may be formed of fabric. Thus, in one example, the side walls 7a, rear wall 7b, bottom 7c, and top 7d may be formed as a fabric covering supported by an inner rigid frame, which may be formed of plastic or metal. In at least one other embodiment, one or more of the walls of the container 7 may be rigid and may, for example, be formed of plastic.

FIG. 16 shows another embodiment of a container 160. The container 160 has side walls 160a, a rear wall 160b, a curved bottom 160c, and a flat top 160d. The top 160d may be configured like top 7d and may have a cover like cover 7e, though such cover is not shown in FIG. 16 for sake of simplicity of illustration. The container 160 is supported by a frame 162 that includes top ring 162a extending around the top 160d and a curved track 162b that extends from the top ring 162a and wraps around the bottom 160c and the side walls 160a. The curved track 162b has opposed side portions 162b′ that extend generally diagonally along the side walls 160a. Each side portion 162b′ is configured to ride in a receiving track formed in or coupled to the rear legs 2a of the frame 2. A front 162a′ of the top ring 162a is configured to pivotally connect to the front member 2c of the frame 2, such as with a hinge or pinned connection, for example. Thus, when the container 160 and the frame 162 are coupled to the frame 2 of the stroller 1, and the stroller is folded, the side portions 162b′ of the curved track 162b can slide in the receiving track formed in or coupled to the rear legs 2a of the frame when the rear legs 2a fold, while the container 160 can pivot about the front 162a′ of the top ring 162. The curvature of the side portions 162b′ is configured to guide the container 160 along a path between the rear legs 2a as they fold.

FIG. 17 shows yet another embodiment of a container 170. The container has features that correspond to container 160 which are incremented by “10” in FIG. 17. One notable difference between container 170 and container 160 is that each side portion 172′ defines a slot or track 174 extending along the side portion 172′. Each slot or track 174 is configured to receive a respective pin 180 (FIG. 18) fixed to a rear leg 2a of the frame 2.

FIGS. 18 to 23 show stroller 1 with frame 2 and container 170. In FIGS. 18 and 19 the stroller frame 2 is open and the container 170 is oriented generally horizontal. FIGS. 20 and 21 show the frame 2 folded in an intermediate position. As the rear legs 2a fold, the container 170 pivots about the front member 2c of the frame 2 while the pins 180 slide in tracks 174 so that the rear side 170b rises between the rear legs 2a. From the intermediate configuration shown in FIGS. 20 and 21, when the rear legs 2a are folded further, the container 170 will slide further relative to the rear legs 2a until the frame 2 is in the fully folded configuration shown in FIGS. 22 and 23. In the fully folded configuration shown in FIGS. 22 and 23, the top side 170d of the container 170 extends substantially parallel with the rear legs 2a and the sides 2b of the frame 2.

There have been described and illustrated herein several embodiments of a stroller and a method of using the stroller. While particular embodiments of the invention have been described, it is not intended that the invention be limited thereto, as it is intended that the invention be as broad in scope as the art will allow and that the specification be read likewise. Thus, while particular mechanisms have been disclosed, it will be appreciated that other mechanisms capable of performing the same functions of the mechanisms described may be used as well. In addition, while particular types of attachable seats have been disclosed, it will be understood that other seats can be used, such as with the afore-mentioned adapter plates. Also, while a carbon fiber frame is preferred, it will be recognized that other materials having similar strength to weight ratios may be used. Also, while a telescoping handle has been described, it will be appreciated that a folding handle may also be used. It will therefore be appreciated by those skilled in the art that yet other modifications could be made to the provided invention without deviating from its spirit and scope as claimed.

1.-15. (canceled)

16. A stroller system, comprising:
a stroller having
a frame configured to support at least one of a stroller seat and an infant car seat, the frame configured to be selectively unfolded in an in-use position and folded in a stowed position;
a suspension leaf having a flexible cantilevered portion fixed at a first end thereof to the stroller frame, the cantilevered portion having a free end spaced from the frame, the cantilevered portion configured to flex about the fixed end;
an elastomeric damper disposed between the first and second ends of the cantilevered portion and the stroller frame, the elastomeric damper configured to compress and expand in response to flexing of said cantilevered portion; and
a wheel connected to an underside of said cantilevered portion of said suspension leaf.

17. The stroller system of claim 16, wherein: the frame includes a unitary u-shaped portion that includes sides of the frame and a front portion of the frame connected to the wheels, the front portion connecting the sides.

18. The stroller system of claim 16, wherein at least one of the frame and the suspension leaf includes carbon fiber.

19. The stroller system according to claim 16, wherein said frame includes:
elongated sides, a front portion connecting said sides, and rear legs pivotally coupled to said sides of said frame, wherein in said unfolded position, said rear legs extend at a non-zero angle relative to said sides of said frame and in said folded position said rear legs extend substantially parallel with said sides of said frame,
plurality of rear wheels that support said rear legs and at least one front wheel supporting said front portion of said frame;
a handle coupled to said sides of said frame; and
a closeable storage container suspended from said rear legs below said stroller seat and infant car seat, wherein said container remains intact and uncrushed when sealed when said stroller is reconfigured between folded and unfolded positions.

20. The stroller system according to claim 19, wherein: said container extends substantially horizontally in the unfolded position and is configured to swing between the rear wheels into a substantially vertical orientation in response to folding the rear wheels.

21. The stroller system according to claim 20, wherein: said container includes a track extending along at least one side of said container, said track in engagement with a guide member of said rear legs, wherein folding of said rear legs causes relative sliding movement between said track and said guide member to guide said container along a path between said horizontal and vertical orientation.

22. The stroller system according to claim 21, wherein: said path is an arcuate path.

23. The stroller system according to claim 21, wherein: said track defines an elongated slot and said guide member includes a pin extending from said rear legs extending into said elongated slot.

24. The stroller system according to claim 21, wherein: said track extends outwardly from the sides of said container and said guide member includes a slot formed in said rear legs configured to receive said outwardly extending track.

25. The stroller system according to claim 16, further comprising:
at least one of a stroller seat and a car seat configured to removably connect to the frame of the stroller.

26. The stroller system according to claim 17, further comprising:
at least one of a stroller seat and a car seat configured to removably connect to the frame of the stroller.

27. The stroller system according to claim 18, further comprising:
at least one of a stroller seat and a car seat configured to removably connect to the frame of the stroller.

28. The stroller system according to claim 19, further comprising:
at least one of a stroller seat and a car seat configured to removably connect to the frame of the stroller.

29. The stroller system according to claim 21, further comprising:
at least one of a stroller seat and a car seat configured to removably connect to the frame of the stroller.

30. The stroller system according to claim 23, further comprising:
at least one of a stroller seat and a car seat configured to removably connect to the frame of the stroller.

31. A stroller suspension system for supporting a stroller frame, said system comprising:
a suspension leaf having a flexible cantilevered portion fixed at a first end thereof to the stroller frame, said cantilevered portion having a second, free end spaced from said frame and said first end, said cantilevered portion configured to flex about said first, fixed end;
an elastomeric damper disposed between said first and second ends of said cantilevered portion and said stroller frame, said elastomeric damper configured to compress and expand in response to said flexing of said cantilevered portion; and
a wheel connected to an underside of said cantilevered portion of said suspension leaf.

32. The suspension system of claim 31, wherein: the suspension leaf is formed of carbon fiber.

33. A stroller, comprising:
a foldable frame configured to selectively removably connect to a stroller seat and an infant car seat, said frame configured to be selectively unfolded in an in-use position and folded in a stowed position, said frame having elongated sides, a front portion connecting said sides, and rear legs pivotally coupled to said sides of said frame, wherein in said unfolded position, said rear legs extend at a non-zero angle relative to said sides of said frame and in said folded position said rear legs extend substantially parallel with said sides of said frame;
plurality of rear wheels that support said rear legs and at least one front wheel supporting said front portion of said frame;
a handle coupled to said sides of said frame; and
a closeable storage container suspended from said rear legs below said stroller seat and infant car seat, wherein said container remains intact and uncrushed when sealed when said stroller is reconfigured between folded and unfolded positions,
wherein said container extends substantially horizontally in the unfolded position and is configured to swing between the rear wheels into a substantially vertical orientation in response to folding the rear wheels,
wherein said container includes a track extending along at least one side of said container, said track in engagement with a guide member of said rear legs, wherein folding of said rear legs causes relative sliding movement between said track and said guide member to guide said container along an arcuate path between said horizontal and vertical orientation.

34. The stroller according to claim 33, wherein: said track defines an elongated slot and said guide member includes a pin extending from said rear legs extending into said elongated slot.

35. The stroller according to claim 33, wherein: said track extends outwardly from the sides of said container and said guide member includes a slot formed in said rear legs configured to receive said outwardly extending track.
